(19) United States
(12) Patent Application Publication
(10) Pub. No.: US 2008/0015999 A1
(43) Pub. Date: Jan. 17, 2008

(54) Securely ingesting encrypted content into content servers

(75) Inventors: Hamid S. Ali, Kirkland, WA (US); Andre Jacobs, Redmond, WA (US); Glenn A. Morten, Bellevue, WA (US)

Correspondence Address: DARBY & DARBY P.C., P.O. BOX 770, Church Street Station, New York, NY, 10008-0770, US

(73) Assignee: Widevine Technologies, Inc., Seattle, WA (US)

(21) Appl. No.: 11/336,693

(22) Filed: Jan. 19, 2006

Related U.S. Application Data
(60) Provisional application No. 60/650,243, filed on Feb. 4, 2005.

(51) Int. Cl. H04L 9/00

(52) U.S. Cl. 705/52

(57) ABSTRACT

A system and method are directed towards including buffer packets into an unencrypted content stream at a same location as encryption related information such as an ECM, an EMM message, or the like, would be in a corresponding encrypted content stream. The buffer packets may comprise virtually any information, including a null packet, an ECM message. By inserting buffer packets in the same location, an overall file size, and frame locationing may be made to match the file size, and frame locationing of the encrypted content stream. The modified unencrypted content stream may be employed to generate trick play files, such as a fast forward file, fast reverse file, and so forth, as well as a corresponding index file that indicates locations of relevant content frames in the unencrypted content stream and the trick play files.

### CROSS-REFERENCE TO RELATED APPLICATIONS

This application claims the benefit of U.S. Provisional Application Ser. No. 60/650,243 filed on Feb. 4, 2005 entitled “System And Method For Ingesting Encrypted Content Into Content Servers,” the benefit of the earlier filing date of which is hereby claimed under 35 U.S.C. § 119 (e) and which is further incorporated by reference.

### BACKGROUND OF THE INVENTION

The present invention relates generally to digital copy protection, digital right management, conditional access and more particularly but not exclusively to managing an ingestion or loading of encrypted files with encryption related information, like Entitlement Control Messages (ECMs), Entitlement Management Messages (EMMs), or the like, into a server, such as a Video-on-Demand (VOD) server, with an indexing file for use in managing trick plays, and the like.

Recent advances in the telecommunications and electronics industry, and, in particular, improvements in digital compression techniques, networking, and hard drive capacities have led to growth in new digital services to a user's home. For example, such advances have provided hundreds of cable television channels to users by compressing digital data and digital video, transmitting the compressed digital signals over conventional coaxial cable television channels, and then decompressing the signals in the user's receiver. One application for these technologies that has received considerable attention recently includes video-on-demand (VOD) systems where a user may communicate with a service operator to request media content and the requested content is routed to the user's home for enjoyment. The service operator typically obtains the content from an upstream content provider, such as a content owner, distributor, and the like.

However, to protect such content from unauthorized use, service operators, content providers, owners, and so forth, may employ a service known as conditional access or digital rights management. Conditional access or digital rights management enables a provider to restrict selected content to selected users. This may be achieved, for example by encrypting the content.

One such encryption approach employs a technique that provides a message known as an Entitlement Control Message (ECM). The ECM is typically a packet which includes information to determine a control word (CW) for use in decrypting the content. In this approach, typically, the streaming content is encrypted using the CW. The CW may be encrypted with a service key via the ECM message. The service key may then be encrypted using an encryption key that may be specific to a user, and sent within a message frame, packet, or the like. The encrypted content, including the ECM may then be provided to a VOD server for storage until it is requested by a user for enjoyment, and/or a downstream distributor, provider, or the like. A content provider, content owner and the like, may wish to encrypt the content as early in a distribution stream as possible to protect the content from piracy.

However, today's users may want to perform various actions on the content, including fast forwarding through a portion of the content, fast reversing, and the like. Such “trick plays” are typically managed by generating additional file information from the content. Creation of these trick play files may be difficult when the content is encrypted. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Invention, which is to be read in association with the accompanying drawings, wherein:

FIG. 1 shows a functional block diagram illustrating one embodiment of an environment for practicing the invention;

FIG. 2 shows one embodiment of a server device that may be included in a system implementing the invention;

FIG. 3 illustrates functional diagrams generally showing one embodiment of possible examples of file formats for use in practicing the invention; and

FIG. 4 illustrates a logical flow diagram generally showing one embodiment of a process for managing an ingestion of encrypted and ECM encoded streaming media without re-indexing, in accordance with the present invention.

### DETAILED DESCRIPTION OF THE INVENTION

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated, the present invention is directed towards a system, apparatus, and method for including buffer packets into an unencrypted content stream at a same location as encryption related information such as an ECM, an EMM message, or the like, would be in a corresponding encyprted content stream. The buffer packets may comprise virtually any information, including a null packet, an ECM message, or the like. By inserting buffer packets in the same location, an overall file size, and frame locationing may be made to match the file size, and frame locationing of the encrypted content stream.

The modified unencrypted content stream may then be employed to generate trick play files, such as a fast forward file, fast reverse file, and so forth. In addition, the modified unencrypted content stream may be used to generate a corresponding index file that indicates locations of relevant content frames in the unencrypted content stream and the trick play files. By employing the modified unencrypted content stream, index files may be readily generated without a need to re-index content streams, thereby reducing an overall processing cost, time, and a possibility of reprocessing content streams.

Once the index file and desired trick play files are generated, the modified content stream may be discarded and/or replaced by the corresponding encrypted content stream for ingestion (loading) into another server.

Illustrative Environment

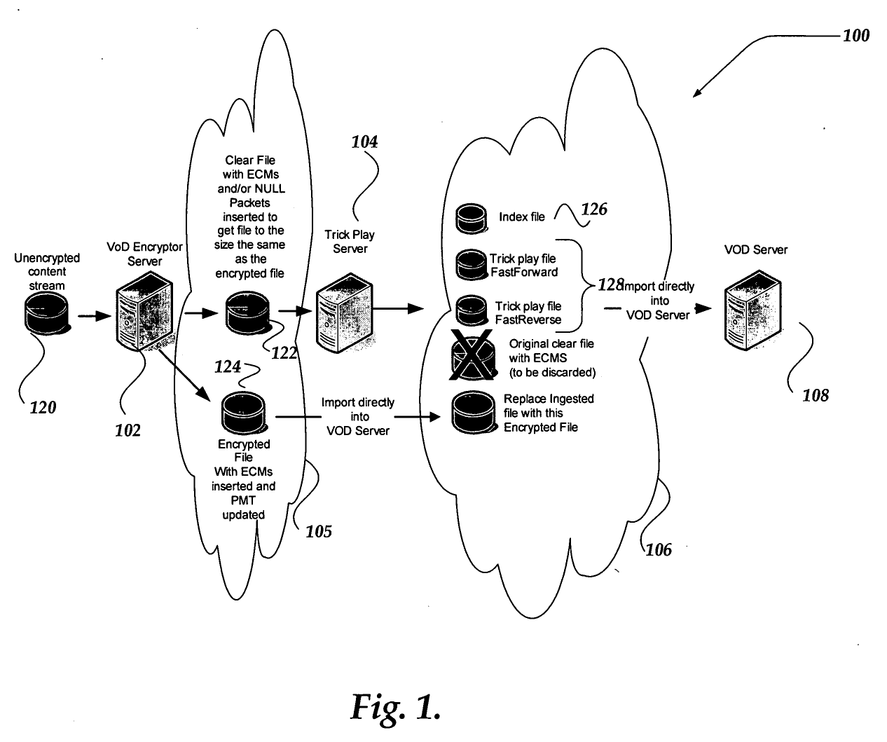

FIG. 1 shows a functional block diagram illustrating one embodiment of operating environment 100 in which the invention may be implemented. Operating environment 100 is only one example of a suitable operating environment and is not intended to suggest any limitation as to the scope of use or functionality of the present invention. Thus, other well-known environments and configurations may be employed without departing from the scope or spirit of the present invention.

As shown in the figure, operating environment 100 includes Video-on-demand (VOD) encryptor server (VES) 102, trick player server (TPS) 104, VOD server 108, and networks 105-106. TPS 104 is in communication with VES 102 through network 105, and VOD server 108 through network 106. VES 102 may be in further communication with VOD server 108 through network 106. Also illustrated are various files, including clear or unencrypted content stream 120, modified unencrypted content stream 122, encrypted content stream 124, index file 126, and trick play files 128.

Unencrypted content stream 120 includes motion pictures, movies, videos, music, pay per view (PPV), video-on-demand (VOD), interactive media, audios, still images, text, graphics, and other forms of digital content. However, unencrypted content stream 120 is not limited to these examples, and virtually any digital content may be included, without departing from the scope or spirit of the invention. In one embodiment, unencrypted content stream 120 is a Moving Pictures Experts Group (MPEG) content stream, such as a transport stream. However, the invention is not so limited, and other file formats may also be employed, without departing from the scope or spirit of the invention.

Briefly, MPEG is an encoding and compression standard for digital broadcast content. MPEG provides compression support for television quality transmission of video broadcast content. Moreover, MPEG provides for compressed audio, control, and even user broadcast content. One embodiment of MPEG-2 standards is described in ISO/IEC 13818-7 (available at http://www.iso.org), which is hereby incorporated by reference.

MPEG content streams may include Packetized Elementary Streams (PES), which typically include fixed (or variable sized) blocks or frames of an integral number of elementary streams (ES) access units. An ES typically is a basic component of an MPEG content stream, and includes digital control data, digital audio, digital video, and other digital content (synchronous or asynchronous). A group of tightly coupled PES packets referenced to substantially the same time base comprises an MPEG program stream (PS). Each PES packet also may be broken into fixed-sized transport packet known as MPEG Transport Streams (TS) that form a general-purpose approach of combining one or more content streams, possible including independent time bases. Moreover, MPEG frames may include intra-frames (I-frames), forward predicted frames (P-frames), and/or bi-directional predicted frames (B-frames).

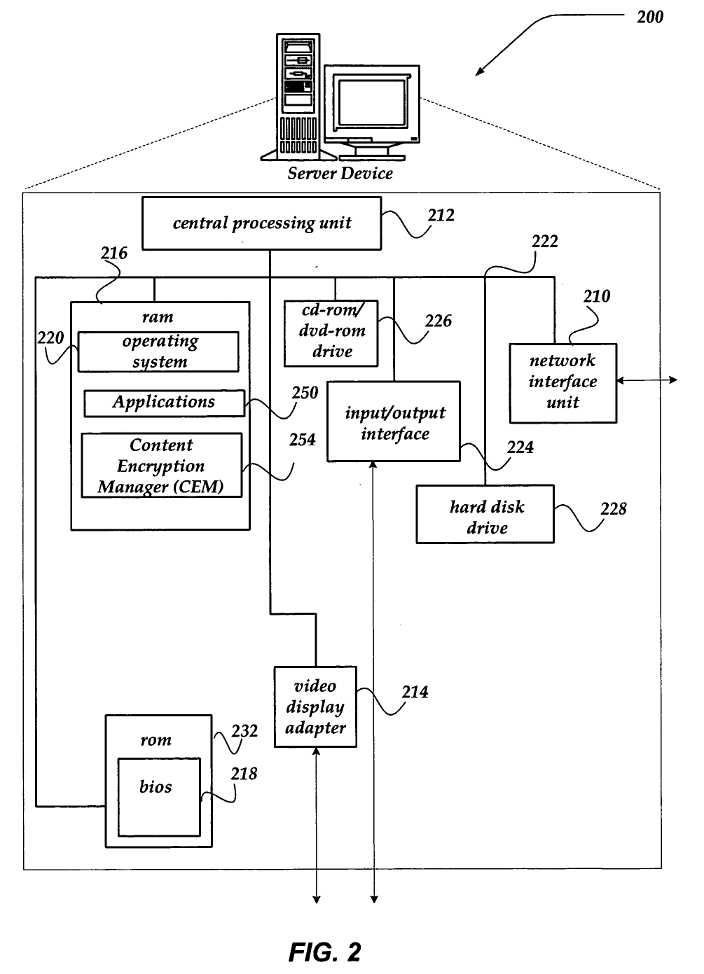

VES 102 is described in more detail below in conjunction with FIG. 2. Briefly, however, VES 102 includes virtually any computing device that is configured to receive unencrypted content stream 120 and provide modified unencrypted content stream 122 and encrypted content stream 124.

TPS 104 includes virtually any computing device that is configured to receive modified unencrypted content stream 122 and to provide index file 126 and trick play files 128. TPS 104 may employ any of a variety of mechanisms to examine modified unencrypted content stream 122 to provide index file 126 and trick play files 128. However, by employing modified unencrypted content stream 122, TPS 104 need not employ cumbrous mechanisms that may include re-indexing files, or the like. This is because frame locations and stream size are consistent with corresponding frame locations in encrypted content stream 124 and overall stream size. Upon generation of index file 126 and trick play files 128, TPS 104 may discard modified unencrypted content stream 122.

VOD server 108 includes virtually any computing device configured to ingest (load or import) files, including index file 126, and trick play files 128. VOD server 108 may store these files for use by another computing device, such as a home user's video set-top-box, television appliance, mobile device, personal digital assistant (PDA), personal computer, jukebox, and the like. Devices that may operate as VES 102, TPS 104, and/or VOD server 108 include personal computers, desktop computers, multiprocessor systems, microprocessor-based or programmable consumer electronics, network PCs, servers, and the like.

Although VES 102, TPS 104, and VOD server 108 are illustrated in FIG. 1 as distinct server devices, the invention is not so limited. For example, the actions associated with VES 102, TPS 104, and/or VOD server 108 may reside on a single computing device, and/or be distributed across additional computing devices (not shown), without departing from the scope or spirit of the invention.

Networks 105-106 are configured to enable various computing devices, such as VES 102, TPS 104, and VOD server 108, to send/receive messages, including files, content streams, or the like. Networks 105-106 are enabled to employ any form of computer readable media for communicating information from one electronic device to another. Also, networks 105-106 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. Networks 105-106 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for computing devices with various degrees of mobility. For example, networks 105-106 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. Moreover, networks 105-106 may further represent various communication mediums including portable memory devices, removable disk drives, CDs, DVDs, or the like. In essence, networks 105-106 include any communication method by which information may travel between one computing device and another computing device.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Illustrative Server Environment

FIG. 2 shows one embodiment of a server device, according to one embodiment of the invention. Server device 200 may include many more components than those shown. The components shown, however, are sufficient to disclose an illustrative embodiment for practicing the invention. Server device 200 may, for example, represent VES 102 of FIG. 1.

Server device 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server device 200. Any general-purpose operating system may be employed. Basic input/output system (“BIOS”) 218 is also provided for controlling the low-level operation of server device 200. As illustrated in FIG. 2, server device 200 also can communicate with the Internet, or some other communications network, such as networks 105-106 in FIG. 1, via network interface unit 210, which is constructed for use with various communication protocols including the TCP/IP protocol. Network interface unit 210 is sometimes known as a transceiver, transceiving device, network interface card (NIC), or the like.

Server device 200 may also include an SMTP handler application for transmitting and receiving email. Server device 200 may also include an HTTP handler application for receiving and handing HTTP requests, and an HTTPS handler application for handling secure connections. The HTTPS handler application may initiate communication with an external application in a secure fashion.

Server device 200 also includes input/output interface 224 for communicating with external devices, such as a mouse, keyboard, scanner, or other input devices not shown in FIG. 2. Likewise, server device 200 may further include additional mass storage facilities such as CD-ROM/DVD-ROM drive 226 and hard disk drive 228. Hard disk drive 228 is utilized by server device 200 to store, among other things, application programs, databases, and the like.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 250 are loaded into mass memory and run on operating system 220. Examples of application programs include email programs, schedulers, calendars, transcoders, database programs, word processing programs, spreadsheet programs, and so forth. Mass storage may further include applications such content encryption manager (CEM) 254.

CEM 254 is configured to employ any of a variety of encryption mechanisms to generate encrypted content stream 124 from a copy of unencrypted content stream 120 of FIG. 1, including, but not limited, to Advanced Encryption Standard (AES), RSA Labs Inc.'s (“RSA's”) RC6, IBM's MARS, TwoFish, Serpent, CAST-256, International Data Encryption Algorithm (IDEA), Data Encryption Standard (DES), Triple DES, DES-EDE2, DES-EDE3, DESX, DES-XEX3; RC2, RC5, Blowfish, Diamon2, TEA, SAFER, 3-WAY, GOST, SHARK, CAST-128, Square, Skipjack, Panama, ARC4, SEAL, WAKE, Sapphire II, BlumBlumShub, RSA, DSA, ElGamal, Nyberg-Rueppel (NR), BlumGoldwasser, Rabin, Rabin-Williams (RW), LUC, LUCELG, ECDSA, ECNR, ECIES, ECDHC, ECMQVC, and/or any other encryption algorithm.

CEM 254 may select to encrypt an video elementary stream (ES), an audio ES, an digital data ES, and/or any combination, and/or any portion of video, audio, data elementary streams of unencrypted content stream 120 to generate encrypted content stream 124. CEM 254 may further select to encrypt at least a portion of an I-frame, P-frame, B-frame, and/or any combination of P, B, and I frames. Moreover CEM 254 may perform such encryption on-the-fly. In one embodiment, CEM 254 provides encrypted content stream 124 to VOD server 108.

CEM 254 may further provide modified unencrypted content stream 122 of FIG. 1 from unencrypted content stream 120 of FIG. 1. CEM 254 may do so, by placing a buffer frame or packet at a location in the modified unencrypted content stream at a same location as an ECM message frame or packet is located in the corresponding encrypted content stream. The buffer frame or packet may include a null packet, a corresponding ECM message frame or packet, or the like. The intent of inserting the buffer frame or packet is to ensure that unencrypted frames within the modified unencrypted content stream are at a same location as is its corresponding encrypted frame in the encrypted content stream. In addition, the overall size of the modified unencrypted frame is intended to be substantially the same as that of the encrypted content stream. Moreover, the modified unencrypted content stream includes a Program Map Table (PMT) that is a copy of the original, unmodified PMT from unencrypted content stream, but with NULL packets having potentially been added based on if the corresponding updated PMT includes more packets. Briefly, the PMT may include program element identifiers (PIDs) for packets in a content stream, such as audio elements, video elements, aux data, program clock references, and the like. A PMT may also include encryption information relative to an ECM message. For example, in one embodiment, the PMT may include a PID associated with the ECM message. By providing an unmodified PMT, generation of trick play files may be further simplified, and enable generation of an index file that is compatible with the encrypted content stream.

CEM 254 may provide modified unencrypted content stream and encrypted content stream at substantially a same time, provide encrypted content stream prior to modified unencrypted content stream, or in virtually any other order, without departing from the scope or spirit of the invention.

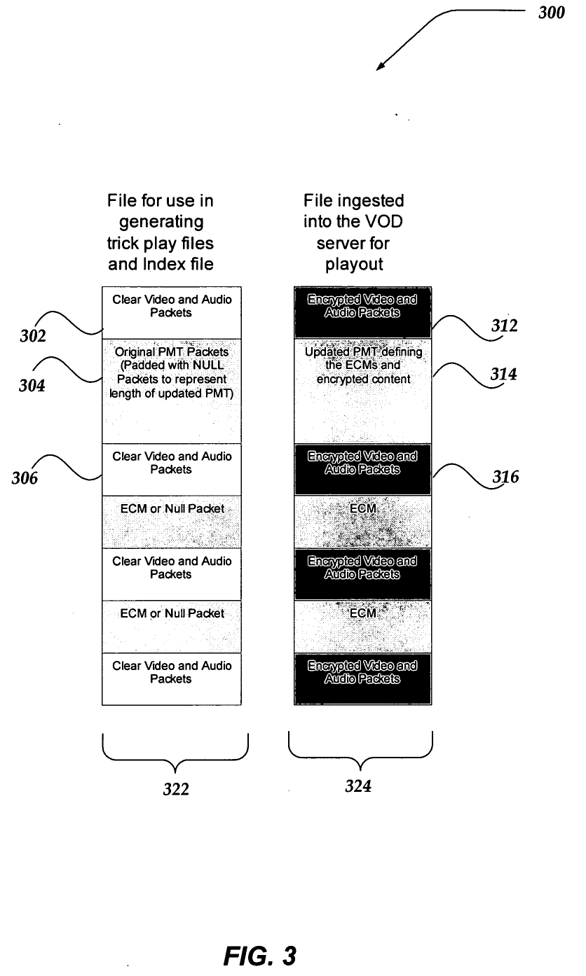

FIG. 3 illustrates functional diagrams generally showing one embodiment of possible examples of file formats for use in practicing the invention. File formats 300 may include many more components than those shown. Moreover, file formats 300 represent only a portion of one embodiment of a content stream and is not intended to illustrate a complete content stream file format. The components shown, however, are sufficient to disclose an illustrative embodiment for practicing the invention.

As shown in FIG. 3, file formats 300 include modified unencrypted content stream 322 and encrypted content stream 324. Modified unencrypted content stream 322 and encrypted content stream 324 are substantially similar to modified content stream 122 and encrypted content stream 124 of FIG. 1.

Encrypted content stream 324 is shown to include encrypted packet 312, updated PMT 314, and ECM 316. Encrypted packet 312 is intended to represent an encrypted video, and/or audio packet using any of a variety of encryption mechanisms, including those described above. Updated PMT 314 represents a program map table that includes information associated with ECM 316 and the like and encrypted packet 312 and the like.

Modified unencrypted content stream 322 is shown to include clear (or unencrypted) packet 302, original PMT 304 potentially padded with NULL packets to represent the length of the modified PMT, and buffer packet 306. As shown buffer packet 306 includes an ECM, null packet, and the like, that is located in a position corresponding to a position of ECM 316 in encrypted content stream 324. Clear packet 302 represents the unencrypted video and/or audio packets from the original unencrypted content stream, in a location that corresponds to a position of encrypted packet 312 of encrypted content stream 324. Original PMT 304 represents an original PMT from the original unencrypted content stream and may not include a definition for ECMS, but it might be padded with NULL packets if the update of the corresponding PMT increases the number of packets of the corresponding PMT. Moreover, an overall size of modified content stream 322 is substantially similar to that of encrypted content stream 324. By generating modified unencrypted content stream 322 in this manner, modified unencrypted content stream 322 provides access to unencrypted content in a structural format that enables the generation of index files and trick play files.

Generalized Operation

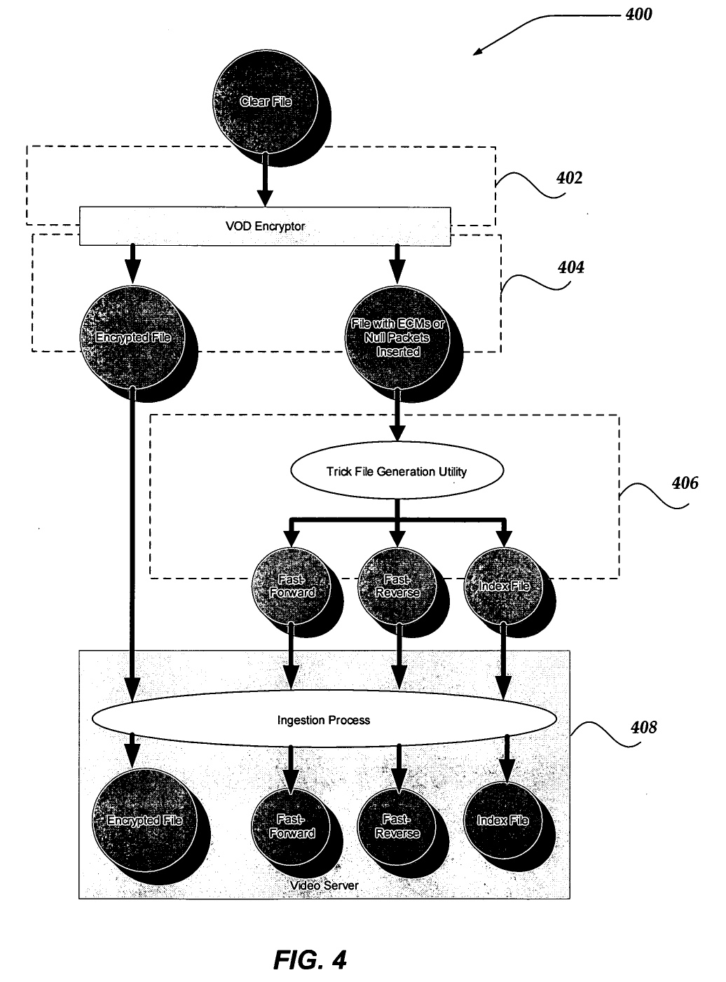

The operation of certain aspects of the invention will now be described with respect to FIG. 4. FIG. 4 illustrates a logical flow diagram generally showing one embodiment of a process for managing an ingestion of encrypted and ECM encoded streaming media without re-indexing, in accordance with the present invention.

As shown in process 400 of FIG. 4, at block 402 a clear (unencrypted) file is received. In one embodiment, the unencrypted file is an unencrypted content stream. The process continues to block 404 where a modified encrypted file that includes a buffer packet and an encrypted file are provided. The modified encrypted file and encrypted file are substantially similar to those described above. Processing continues to block 406, where the modified encrypted file is employed to generate an index file and trick play files. In one embodiment, at block 406, the modified encrypted file may be discarded, destroyed, and the like. Processing next flows to block 408, where the trick files, index file, and encrypted file are ingested or loaded into a video server, for storage and possibly for streaming. Upon completion of block 408, processing may return to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. A server device for managing content encryption, comprising:
a transceiver for receiving and sending information between another computing device;
a processor in communication with the display and the transceiver; and
a memory in communication with the processor and for use in storing data and machine instructions that causes the processor to perform a plurality of operations, including:
receiving an unencrypted file;
encrypting a copy of the unencrypted file;
inserting a message associated with encryption information within the encrypted file;
modifying the unencrypted file to include a buffer packet at a location corresponding to a location of the message within the encrypted file; and
enabling the modified unencrypted file to be used to generate at least one of an index file or a trick play file.

2. The server device of claim 1, wherein the buffer packet includes at least one of an ECM and a null packet.

3. The server device of claim 1, wherein the modified unencrypted content stream and the encrypted content stream are of a same file size.

4. The server device of claim 1, the actions further comprising:
discarding the modified unencrypted file after generation of the at least one index file or trick play file; and
employing the encrypted file during a serving of content to an end-user.

5. The server device of claim 1, the actions further comprising:
modifying a Program Map Table (PMT) by including additional encryption information into the PMT;
inserting the modified PMT within the encrypted file;
padding an unmodified copy of the PMT with at least one null packet such that the padded PMT is of a same size as the modified PMT; and
inserting the padded PMT into the unencrypted file at a frame position corresponding to a frame position of the modified PMT within the encrypted file.

6. The server device of claim 1, wherein unencrypted file employs an MPEG format.

7. The server device of claim 1, wherein the unencrypted file further comprises at least one of a motion picture, a video, an audio file, still images, text, graphics, pay per view file, an interactive media, or a video on demand file.

8. A method for use in for managing content encryption, comprising:
receiving an unencrypted content stream;
encrypting a copy of the unencrypted content stream;
inserting a message associated with encryption information within the encrypted content stream;
modifying the unencrypted content stream to include a buffer packet at a location corresponding to a location of the message within the encrypted content stream such that the modified unencrypted content stream and the encrypted content stream are of a same file size; and
enabling the modified unencrypted content stream to be used to generate at least one of an index file or a trick play file.

9. The method of claim 8, wherein the buffer packet includes at least one of an ECM and a null packet.

10. The method of claim 8, further comprising:
discarding the modified unencrypted content stream upon generation of the at least one index file or trick play file.

11. The method of claim 8, further comprising:
inserting a Program Map Table (PMT) into the encrypted content stream, the PMT being modified with additional encryption information;
padding an unmodified copy of the PMT with at least one null packet such that the padded PMT is of a same size as the modified PMT; and
inserting the padded PMT into the unencrypted content stream at a frame position corresponding to a frame position of the modified PMT within the encrypted content stream.

12. The method of claim 8, wherein the unencrypted content stream further comprises at least one of a motion picture, a video, an audio content stream, still images, text, graphics, pay per view content stream, an interactive media, or a video on demand content stream.

13. A modulated data signal configured to include program instructions for performing the method of claim 8.

14. A system for use in for managing content encryption over a network comprising:
an encryption server that includes program instructions that are operative to perform actions, comprising:
receiving an unencrypted file;
encrypting a copy of the unencrypted file;
inserting a message associated with encryption information within the encrypted file;
modifying the unencrypted file to include a buffer packet at a location corresponding to a location of the message within the encrypted file; and
forwarding the modified unencrypted file; and
a trick play server that is in communication with the encryption server and includes program instructions operative to perform actions, comprising:
receiving the modified unencrypted file; and
generating at least one of an index file or a trick play file based on the modified unencrypted file.

15. The system of claim 14, wherein the actions of the trick play server further comprising:
discarding the modified unencrypted file after generation of the at least one index file or trick play file.

16. The system of claim 14, further comprising:
a server that is in communication with the trick play server and the encryption server and includes program instructions operative to perform actions, including:
receiving the at least one trick play file or index file; and
employing the encrypted file and the at least one trick play file or index file during a serving of content to an end-user.

17. The system of claim 14, wherein the buffer packet includes at least one of an ECM and a null packet.

18. A computer-readable medium having stored thereon a data structure useable in generating a trick play file, comprising:
a plurality of first data fields, each data field within the plurality of first data fields comprising at least one of a video or an audio data packet within an unencrypted content stream; and
at least one second data field comprising a buffer packet, the at least one second data field being inserted at a frame location between at least two first data fields corresponding to a frame location of at least one of an ECM or an EMM message in an encrypted content stream that is derived from the unencrypted content stream, wherein the insertion of the at least one second data field results in the data structure being of a same size as the encrypted content stream.

19. The computer-readable medium of claim 18, wherein the at least one second data field further comprises a same size as the corresponding ECM or EMM message in the encrypted content stream.

20. The computer-readable medium of claim 18, wherein the buffer packet includes at least one of an ECM and a null packet.

21. An apparatus for managing content encryption over a network, comprising:
a transceiver to receive input data over the network; and
means for generating a modified unencrypted content stream by including at least one buffer packet within an unencrypted content stream at a location corresponding to a location of an encryption message within an encrypted copy of the unencrypted content stream that includes at least one encryption message, such that the modified unencrypted content stream may be employed to generate at least one of an index file or a trick play file.

22. The apparatus of claim 21, wherein the encryption message further comprises at least one of an ECM message or an EMM message.

23. The apparatus of claim 21, wherein the modified unencrypted content stream and the encrypted copy are of a same overall file size, and wherein the buffer packet is of a same size as the corresponding encryption message.
